(19) United States
(12) Patent Application Publication
(10) Pub. No.: US 2005/0002351 A1
(43) Pub. Date: Jan. 6, 2005

(54) Method for receiving call in a mobile communication system

(76) Inventors: Dong-Keon Kong, Suwon-si (KR); Tae-Won Kim, Yongin-si (KR); Jae-Jeong Shim, Seoul (KR); Hong-Sung Chang, Suwon-si (KR); Seung-II Yoon, Seongnam-si (KR); Jong-Bum Pyo, Yongin-si (KR); Dae-Gyun Kim, Seongnam-si (KR); Beom-Sik Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/868,973

(22) Filed: Jun. 17, 2004

(30) Foreign Application Priority Data
Jun. 17, 2003 (KR) 2003-39258

(51) Int. Cl. H04Q 7/00

(52) U.S. Cl. 370/328; 370/352

(57) ABSTRACT

A method for delivering a received frame packet, to be transmitted from a packet data service node to a mobile station in a dormant state by a packet control function in a mobile communication system capable of providing data service or Push-To-Talk (PTT) service to the mobile station, via a base station connected to the packet control function. The packet control function delivers the received packet data and paging data to the base station where the mobile station in the dormant state is located. The base station forms the received packet data into an SDB (Short Data Burst), includes the SDB in a DBM (Data Burst Message) message, and transmits the DBM message to the mobile station if an analysis result of the received paging data indicates that the mobile station in the dormant state has requested fast packet paging and the base station can currently provide the fast packet paging.

### CROSS-REFERENCE TO RELATED APPLICATIONS

This application claims the benefit under 35 U.S.C. § 119(a) of Korean Patent Application No. 2003-39258 entitled “Method for Receiving Call in a Mobile Communication System”, filed in the Korean Intellectual Property Office on Jun. 17, 2003, the entire contents of which are incorporated herein by reference.

### BACKGROUND OF THE INVENTION

1. Field of the Invention

The present invention relates generally to a method for receiving a call in a mobile communication system. More particularly, the present invention relates to a method for receiving a call in a dormant state with minimum delay.

2. Description of the Related Art

Generally, mobile communication systems perform voice communication over radio channels. Due to the development of communication technology, the mobile communication systems now support data service as well as voice service, and significant research is being conducted on technologies for supporting even more data at higher speeds.

Such mobile communication systems typically require a method for efficiently managing channel resources in order to support the data service. This is due, in part, because in the mobile communication systems, transmission of packet data for the packet service continuously occupies traffic channels, thereby resulting in a waste of channel resources. More specifically, data traffic such as packet data, is typically generated discontinuously or on a burst basis, such that a non-data transmission period lasts for some time after transmission of the generated data. Therefore, if a channel assigned for voice communication is continuously maintained, channel resources available in the system are exhausted, restricting channel access by other users.

In order to resolve this problem, a dormant state has been defined for the case where there is no data transmission for some period of time after the abrupt transmission of data traffic for a short time. The dormant state refers to a state in which, if there is no data traffic to transmit for a predetermined time after assignment of a traffic channel, the assigned traffic channel only is released. Therefore, it is possible to resume traffic transmission at any time by activating the traffic channel. By defining the dormant state, it is possible to assign channel resources to more users. In addition, when compared with a method of releasing all channels and setting up the channels again when necessary, the method of releasing and setting up only the traffic channel contributes to simplification of a signaling procedure, thereby improving the load and channel environment characteristics of mobile stations and mobile communication systems.

With reference to FIG. 1, a description will now be made of an example method for setting up and sending a call in a dormant state. FIG. 1 is a signaling diagram illustrating a procedure for sending a short data burst (SDB) call by a mobile station in a dormant state in a typical mobile communication system.

Referring to FIG. 1, a mobile station (MS) 10 and nodes 20, 30, 40 and 50 of a mobile communication system maintain a dormant state in step 100. Thus, the mobile station 10 and particular nodes of the mobile communication system maintain PPP (Point-to-Point Protocol) connection. When the mobile station 10 desires to send an SDB call, the mobile station transmits a short data burst (SDB) carried by a data burst message (DBM) to a base station (BS) 20 over an access channel, or over a reverse enhanced access channel (R-ACH) in step 101. Then, in step 102, the base station 20 generates a Layer 2 acknowledgement (Ack), and transmits the Layer 2 Ack to the mobile station 10 over a paging channel, or over a forward common control channel (F-CCCH).

When authentication is necessary, the base station 20 transmits authentication parameters received from the mobile station 10 to a mobile switching center (MSC) 30 using an ADDS (Application Data Delivery Service) Transfer message in step 103. In response, in step 104, the mobile switching center 30 performs authentication on the mobile station 10, and delivers an ADDS Transfer Ack message to the base station 20. When the authentication is successful, the base station 20 delivers, in step 105, a data burst message (DBM) in an SDB format to a packet control function (PCF) 40. In step 106, the packet control function 40 transmits packet data to a packet data service node (PDSN) 50.

With reference to FIG. 2, a description will now be made of an example method for receiving an SDB data call. FIG. 2 is a signaling diagram illustrating an example procedure for receiving an SDB data call by a mobile station in a dormant state in a typical mobile communication system.

Referring to FIG. 2, when packet data is to be received at a mobile station 10 in a dormant state, a packet data service node 50 generates a PPP frame and delivers the PPP frame to a packet control function 40 in step 201. In step 202, the packet control function 40 reconfigures the packet into an SDB format, and delivers the SDB message to a base station 20. In step 203, the base station 20, after receiving the SDB message, then delivers an Ack signal (or response signal) to the packet control function 40. Thereafter, in step 204, the base station 20 transmits the received SDB directly to the mobile station 10, or performs an ADDS page procedure or a reactivation procedure with a mobile switching center 30. In FIG. 2, the base station 20 is shown transmitting the SDB directly to the mobile station 10 as an example. If the base station 20 performs the reactivation procedure, it transmits an SDB over a traffic channel (TCH) after the reactivation procedure. Upon receiving the SDB, the mobile station 10 generates a Layer 2 Ack signal and delivers the Layer 2 Ack signal to the base station 20 in step 205.

If the base station 20 fails to receive the Layer 2 Ack signal from the mobile station 10, the base station 20 transmits, in step 206, an SDB to be transmitted to the mobile station 10, to the mobile switching center 30 using a BS Service Request message. Upon receiving the BS Service Request message, the mobile switching center 30 generates a BS Service Response message and delivers the BS Service Response message to the base station 20 in step 207. If an ADDS page procedure is performed before the SDB transmission between the base station 20 and the mobile switching center 30, steps 204 and 205 can be omitted. If the base station 20 receives the BS Service Response message from the mobile switching center 30 in step 207, the base station 20 performs an ADDS page procedure with the mobile switching center 30 in step 208.

Based on the results of the ADDS page procedure, the base station 20 again generates an SDB message and transmits the SDB message to the mobile station 10 in step 209. When the SDB message is received, the mobile station 10 delivers a Layer 2 Ack message to the base station 20 in step 210.

As described above, packet data is received at the mobile station 10 through a very complicated procedure, thereby increasing a time required in sending and receiving a packet call. The increase in time for sending and receiving a packet call results in a significant waste of resources for signal processing of the system and a reduction in quality-of-service (QoS).

In the current mobile communication system, a method for searching paging channels of a mobile station is divided into a slotted mode and a non-slotted mode. In the non-slotted mode, a mobile station searches all paging slots in all cycles to determine whether or not a paging signal is received. Therefore, the non-slotted mode results in excessive battery consumption of the mobile station. Thus, in the current mobile communication system, mobile stations typically operate in the slotted mode. In this mode, notice of a slot cycle index is provided to a base station by a mobile station when communication is initially originated. In providing a notice of the slot cycle index to the base station, the mobile station sends the slot cycle index using an Origination message, a Registration message, or a Paging Response message.

Currently, most mobile communication service providers use a slot cycle index (SCI) with a large value (e.g., SCI=2). The slot cycle index value is not changed even though a mobile station may make a state transition. Such a slot cycle index value is defined in a standard for a mobile communication system, and wherein still further fields are defined, for example, in CDMA2000 Release D, a separate SIGN_SLOT_CYCLE_INDEX field is defined. If a value of the field is ‘1’, the slot cycle index is a positive number, and if a value of the field is ‘0’, the slot cycle index is a negative number. A value of the slot cycle index for a mobile station can be set to one of the following values: −4, −3, −2, −1, 0, 1, 2, 3, 4, 5, 6, 7.

Next, a description will be provided of an example method for providing data service to a mobile station that has made a state transition to the dormant state. A base station and packet control function (BS/PCF) can transmit data with an SDB without activating a traffic channel for a short IP (Internet Protocol) signal message. In contrast, for packet data having a larger size, the base station and packet control function sends a radio paging signal to a mobile station, activates a traffic channel, and then transmits the packet data over the traffic channel. As described above, the mobile station must undergo authentication by a mobile switching center when transmitting an SDB, and a time delay occurs when the SDB is received via the mobile switching center for paging to the mobile station.

As the base station must deliver an ADDS message and SDB data together to the mobile switching center, the frequent occurrence of the SDB can impose a load on the mobile switching center. When SCI with a large value for a mobile station is used, a battery life of the mobile station is increased and a period for which the mobile station searches a paging slot is also increased, which undesirably increases a time required in receiving an SDB by the other mobile station. Therefore, for fast paging to a mobile station, an SCI value is set to a negative value or used for a non-slotted mode, and such an operation is called a “suspended mode.”

If a mobile station continuously operates in the suspended mode, a battery life of the mobile station is undesirably reduced. In IP service provided with an open communication session, it is possible to determine when incoming service will occur to the mobile station, but it is not typically possible to determine when other services will occur to the mobile station. Additionally, the current mobile communication system cannot detect service situations of the mobile station, i.e., cannot determine whether the mobile station is performing in a suspended mode.

Due to the development of communication technologies, Code Division Multiple Access (CDMA) mobile communication systems are developing into systems which are capable of providing high-speed data service and systems capable of providing both voice service and high-speed data service. In addition to the diversity of the mobile communication systems, the voice services are also developing into various call services, such as group call service and Push-To-Talk (PTT) service, in addition to the existing person-to-person call service (or 1:1 call service).

In an example of the advanced call services, a typical PPT service can include multiple users wherein, after several users start an initial call, a particular user can attempt a voice call by pressing a push button prepared in his or her mobile station. A mobile communication system, which is providing the PTT service, is constructed such that, if there is a call request from a mobile station, voice signals in a direction of other users are transmitted to the other users. Then, all other users desiring not to transmit voice signals receive transmitted voice signals only.

In most cases, the PTT call is used between users in a particular group. For example, the PTT call can be used for unidirectional communication between a taxi operator and members of a taxi union (i.e., taxi drivers) when taxi reservation service is provided using phones between members of the taxi union. In addition, the PTT service can be used for replacing walkie-talkies in construction work or similar fields. However, the PTT service can also be extended to users receiving normal service for a mobile terminal to provide a small-scale group call or a restrictive 1:1 call. Therefore, developers of the mobile communication systems are developing technologies for providing PTT services in the same manner as packet data services.

Accordingly, a need exist for a system and method to rapidly perform data exchange and forwarding procedures without the delays noted above, such as those delays associated with interactions with a mobile switching center.

### SUMMARY OF THE INVENTION

It is, therefore, an object of the present invention to provide a method for reducing the time required in sending packet paging to a destination mobile station when a mobile station requests fast connection for data service in a mobile communication system.

It is another object of the present invention to provide a method for rapidly providing an SDB to a destination mobile station without performing an interaction procedure with a mobile switching center in a mobile communication system.

It is another object of the present invention to provide a method for rapidly providing a packet paging message to a destination mobile station without performing an interaction with a mobile switching center in a mobile communication system.

It is yet another object of the present invention to provide a method for improving service quality-of-service (QoS) by rapidly processing an outgoing call and an incoming call in a mobile communication system.

To achieve the above and other objects, a method is provided for delivering a received frame packet, wherein the frame packet is to be transmitted from a packet data service node to a mobile station in a dormant state by a packet control function in a mobile communication system. The communication system is capable of providing data service or Push-To-Talk (PTT) service to the mobile station via a base station connected to the packet control function. The packet control function delivers the received packet data and paging data to the base station where the mobile station, in the dormant state, is located. The base station forms the received packet data into an SDB (Short Data Burst), and includes the SDB in a DBM (Data Burst Message) message. The base station then transmits the DBM message to the mobile station if an analysis result of the received paging data indicates that the mobile station, in the dormant state, has requested fast packet paging, and the base station can currently provide the fast packet paging.

The paging data includes location information of the mobile station in the dormant state, SCI (Slot Cycle Index), and SCM (Station Class Marker). The fast packet paging is requested when an SCI value is set to a negative number or the base station operates in a non-slotted mode.

Such fast packet paging is requested by the mobile station during data communication, and the fast packet paging is performed using location information of the mobile station, SCI, SCM, a fast packet paging enable bit and a timer value, all of which are stored in the packet control function.

A request message for the fast packet paging includes a duration counter value indicating a time required for fast paging, and the fast packet paging is performed for the duration timer value.

Further, the packet control function determines whether it can transmit a frame packet received from the packet data service node with an SDB by itself if there is no request for transmitting the received frame packet with the SDB.

The packet control function then determines to transmit the received packet data with the SDB by itself if a size of the received frame packet is smaller than a predetermined size.

The packet control function then also determines to transmit the received packet data with the SDB by itself if a reception number of the received frame packet is smaller than or equal to the possible maximum transmission number per predetermined time.

The base station stops performing an interaction procedure with a mobile switching center during packet paging or SDB paging to the mobile station.

To achieve the above and other objects, a method is provided for performing paging upon receiving a frame packet to be transmitted to a mobile station in a dormant state in a mobile communication system capable of providing packet data service to the mobile station via a base station. The mobile communication system includes a packet data service node capable of receiving packet data, and a packet control function connected to the packet data service node. The method comprises the steps of providing the packet control function to determine whether fast paging is requested for the received packet data, and if fast paging is requested, delivering the received packet data through an SDB (Short Data Burst) message via a base station where the mobile station is located.

The determination step further comprises the step of determining whether fast paging is requested by the packet data service node.

The determination step further comprises the step of determining whether the received packet data is smaller than a predetermined size, and determining that fast paging is requested if the received packet data is smaller than the predetermined size.

The determination step still further comprises the step of determining whether a reception number of packet data is smaller than a threshold value within a predetermined time, and determining that fast paging is requested if the reception number of the packet data is smaller than the threshold value within the predetermined time.

### BRIEF DESCRIPTION OF THE DRAWINGS

The above and other objects, features and advantages of the present invention will become more apparent from the following detailed description when taken in conjunction with the accompanying drawings in which:

FIG. 1 is a signaling diagram illustrating an example procedure for sending a short data burst (SDB) call by a mobile station in a dormant state in a typical mobile communication system;

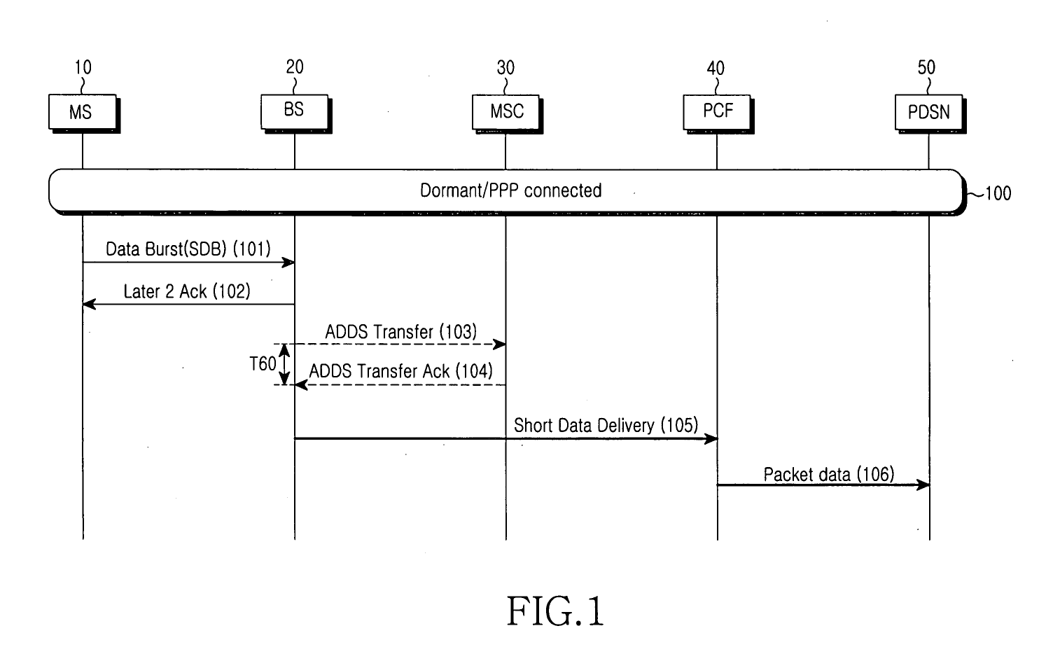

FIG. 2 is a signaling diagram illustrating an example procedure for receiving an SDB data call by a mobile station in a dormant state in a typical mobile communication system;

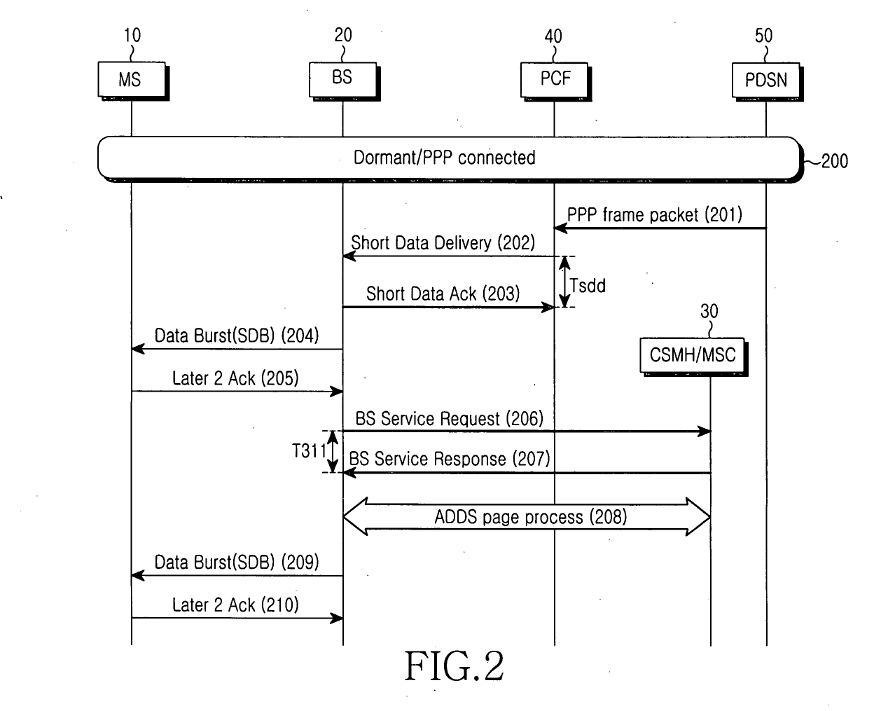

FIG. 3 is a signaling diagram illustrating an example method for receiving an SDB call in a mobile station in a dormant state according to an embodiment of the present invention; and

FIG. 4 is a basic signaling diagram illustrating an example procedure for receiving a data call according to an embodiment of the present invention.

### DETAILED DESCRIPTION OF THE EXEMPLARY EMBODIMENTS

A preferred embodiment of the present invention will now be described in detail with reference to the drawings. In the drawings, the same or similar elements are denoted by the same reference numerals even though they are depicted in different drawings. In the following description, a detailed description of known functions and configurations incorporated herein has been omitted for conciseness.

The present invention provides at least the following three methods for rapidly providing messages. First, the present invention provides a method for rapidly processing packet paging when a mobile station requiring data service requests fast connection in a mobile communication system. Second, the present invention provides a method for rapidly providing an SDB message to a mobile station without an interaction procedure with a mobile switching center in a mobile communication system. Third, the present invention provides a method for rapidly providing a paging message to a mobile station without an interaction with a mobile switching center in a mobile communication system.

A packet control function (PCF) according to an embodiment of the present invention includes the following differences when compared with the conventional packet control functions described above. First, the packet control function of the present invention does not perform authentication on an SDB outgoing call. That is, the packet control function delivers SDB data directly to a packet data service node without performing authentication thereon through a mobile switching center, thereby reducing a call sending time for SDB call service.

Second, the packet control function of the present invention preferably tracks a position of a mobile station. When a PPP frame is received through the tracking, the packet control function can perform paging to the tracked position of the mobile station without interaction with a mobile switching center. In order to perform this process, the packet control function preferably stores such data as a slot cycle index (SCI) and a station class marker (SCM).

According to the present invention, in order to reduce a time required for paging, a slot cycle index value used by a mobile station is set to a negative value, or a non-slotted mode is used. To this end, during service negotiations between a mobile station and a mobile communication system, it is determined whether a negative-signed slot cycle index is to be used.

In order to reduce a time required for packet paging used in MS-terminated SDB and network-initiated reactivation procedures, a system and a mobile station operate in a non-slotted mode or a slotted mode for a predetermined time. In the case of the slotted mode, an SCI smaller than an originally used SCI, or a negative-sized SCI, is used. Herein, such an operation mode will be defined as a “packet suspended mode”. In the packet suspended mode, a fast packet paging operation is available.

To support the fast packet paging operation, a base station system preferably informs a mobile station whether it supports a fast packet paging procedure during service negotiation. A mobile station sends information related to desired fast packet paging, included in an SDB message type, to a base station (BS/PCF), and the base station (BS/PCF) stores the transmitted information and uses the stored information when performing packet paging to the mobile station.

In the fast packet paging procedure, if a mobile station and a base station use a non-slotted mode or a negative-signed SCI, a period for which the mobile station searches a paging slot is reduced, thereby enabling fast packet paging. After a lapse of a predetermined time, the packet suspended mode can be changed back to the normal operation mode. Table 1 illustrates example slot search periods of mobile stations in association with slot cycle indexes.

TABLE 1

| SLOT_CYCLE_{—} | SIGN_SLOT_{—} | |
|---|---|---|
| INDEX | CYCLE_INDEX | Slot Cycle Length |
| 111 | 0 | Reserved |
| 110 | 0 | Reserved |
| 101 | 0 | Reserved |
| 100 | 0 | 0.08 s (1 slot) |
| 011 | 0 | 0.16 s (2 slot) |
| 010 | 0 | 0.32 s (4 slot) |
| 001 | 0 | 0.64 s (8 slot) |
| 000 | 0 or 1 | 1.28 s (16 slot) |
| 001 | 1 | 2.56 s (32 slot) |
| 010 | 1 | 5.12 s (64 slot) |
| 011 | 1 | 10.24 s (128 slot |
| 100 | 1 | 20.48 s (256 slot) |
| 101 | 1 | 40.96 s (512 slot) |
| 110 | 1 | 81.92 s (1024 slot) |
| 111 | 1 | 163.84 s (2048 slot) |

In the case of group call service, such as PTT service or data communication through SLOT_CYCLE_INDEX and SIGN_SLOT_CYCLE_INDEX of Table 1, a mobile station and a base station use a negative-signed slot cycle index in an SDB call, and a period for which the mobile station searches a paging slot can be reduced.

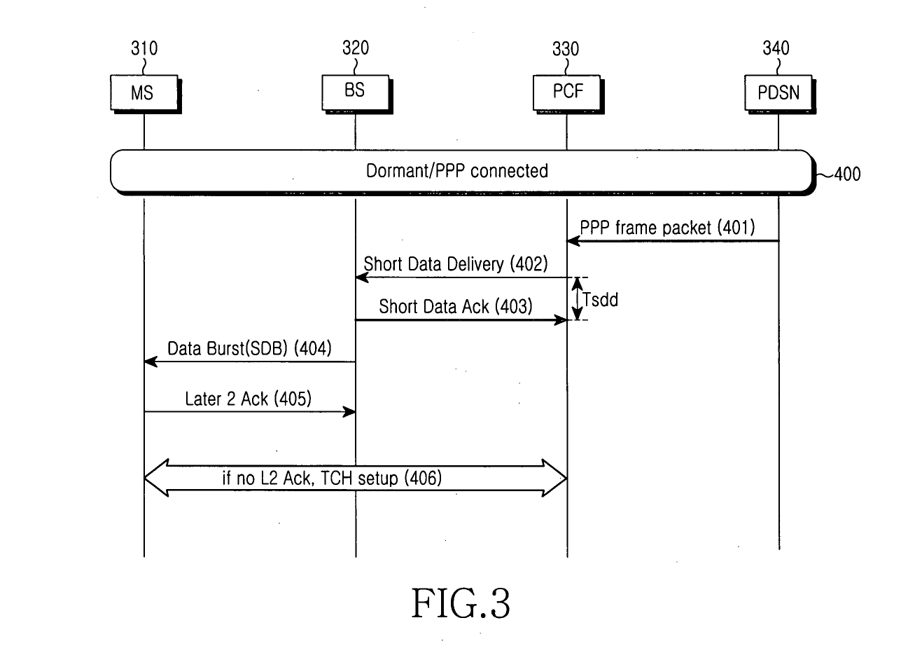

FIG. 3 is a signaling diagram illustrating an example method for receiving an SDB call in a dormant state according to an embodiment of the present invention. Referring to FIG. 3, a dormant state is maintained between a mobile station (MS) 310 and a packet data service node (PDSN) 340 in step 400. The dormant state between the mobile station 310 and the packet data service node 340 refers to a state in which no packet data is transmitted for a predetermined time after initial call setup. Therefore, only PPP connection is being maintained between the mobile station 310 and the packet data service node 340.

If packet data should be received at the mobile station 310 in the dormant state, the packet data service node 340 transmits a PPP frame packet to a packet control function (PCF) 330 in step 401. The packet control function 330 receiving the PPP frame packet then determines whether it will transmit the received PPP frame with an SDB or a traffic channel. There are several determination methods which can be applied by the packet control function 330.

In a first determination method, the packet control function 330 generates and transmits an SDB message when it is necessary to transmit a PPP frame packet received from the packet data service node 340 with an SDB. However, if the packet control function 330 fails to receive information on the transmission method from the packet data service node 340, the packet control function 330 can selectively use a traffic channel or an SDB according to a size of the packet. For example, if the received frame packet is smaller than a predetermined size, the packet control function 330 selects an SDB and delivers the frame packet with the SDB. However, if the received frame packet is larger than the predetermined size, the packet control function 330 sets up a traffic channel and delivers the frame packet with the traffic channel. For example, a maximum size of data that can be transmitted with the SDB can be 254 bytes.

In a second determination method, a possible maximum transmission number of an SDB per given time is used. In this method, the packet control function 330 determines whether a reception number of an SDB is larger than or equal to the possible maximum transmission number, and sets up a traffic channel without requesting SDB paging if the reception number is larger than or equal to the possible maximum transmission number. Through one of the above methods or a combination of the above methods, the packet control function 330 can determine whether it will transmit the received PPP frame packet with an SDB, or transmit the received PPP frame packet with a traffic channel.

It will be assumed herein for this example, that the packet control function 330 transmits the received PPP frame packet with an SDB. In addition, because the packet control function 330 includes position information of the mobile station 310, the packet control function 330 can immediately perform paging.

In step 402, the packet control function 330 delivers an SDB message to a base station (BS) 320 according to the determination result. The packet control function 330 delivers paging information stored therein, such as location information, SCM and SCI, to the base station 320 together with the SDB message. When the SDB message is received, the base station 320 generates a response signal (Short Data Ack) and sends the Short Data Ack to the packet control function 330 in step 403.

A detailed description will now be made of a slot cycle for paging according to an embodiment of the present invention. In the current mobile communication system, a non-negotiable service configuration record (NNSCR) defining non-negotiable service configuration parameters to be used by the mobile station is transmitted to the mobile station using a Service Connect message during service negotiations with a mobile station. That is, a time required for paging can be reduced for the data service or the PTT service using the non-negotiable service configuration record.

In the present invention, one of the NNSCR bits can be defined as a FAST_PKT_PAGE_ENABLE bit. A base station informs a mobile station whether it supports a fast packet paging procedure during service negotiation using the fast packet paging enable bit FAST_PKT_PAGE_ENABLE. The NNSCR example according to an embodiment of the present invention is illustrated in Table 2.

TABLE 2

| Field | Length (bits) |
|---|---|
| FPC_INCL | 1 |
| FPC_PRI_CHAN | 0 or 1 |
| FPC_MODE | 0 or 3 |
| FPC_OLPC_FCH_INCL | 0 or 1 |
| FPC_FCH_FER | 0 or 5 |
| . | . |
| . | . |
| . | . |
| SR_ID | 3 |
| SDB_SO_OMIT | 1 |
| FAST_PKT_PAGE_ENABLE | 1 |
| RESERVED | 0-7 (as needed) |
| . | . |
| . | . |
| . | . |

If a FAST_PKT_PAGE_ENABLE field of the NNSCR illustrated in Table 2 is set to ‘0’, a mobile station and a base station will operate in a normal mode. However, if the FAST_PKT_PAGE_ENABLE field of NNSCR is set to ‘1’, the fast packet paging procedure can be performed.

In addition, a mobile station transmits an SDB to a packet control function after including a FAST_PKT_PAGE_INFO field in an SDB message type, therefore the mobile station can designate a desired operation mode on each occasion. In the present invention, in order for a mobile station to include the FAST_PKT_PAGE_INFO field in the SDB message type before transmission, the following method example is proposed. The existing SDB message type provides the FAST_PKT_PAGE_INFO field included therein, and has one indication bit indicating whether the FAST_PKT_PAGE_INFO field is included in the SDB message type. The current SDB data has 4 RESERVED bits, which are generally set to ‘0000’. However, according to the present invention, a first bit among the 4 RESERVED bits is used as a FAST_PKT_PAGE_INCL bit. That is, if the 4 RESERVED bits in the SDB message type are set to ‘1000’, a FAST_PKT_PAGE_INFO field is newly added. However, if the 4 RESERVED bits are set to ‘0000’, the FAST_PKT_PAGE_INFO field is omitted.

The SDB format example according to an embodiment of the present invention is illustrated in Table 3.

TABLE 3

| Field | Length (bits) |
|---|---|
| SR_ID | 3 |
| SO_OMIT | 1 |
| FAST_PKT_PAGE_INCL | 1 |
| RESERVED | 3 |
| SO | 16 |
| FAST_PKT_PAGE_INFO | 8 |
| DATA BLOCK | Variable (max. 253 byte) |

It can be understood from Table 3 that the newly added FAST_PKT_PAGE_INFO field is comprised of 8 bits. Example definitions of the 8 individual bits constituting the newly added FAST_PKT_PAGE_INFO field are illustrated in Table 4.

TABLE 4

| Duration | Slotted | SIGN_SLOT_{—} | SLOT_CYCLE_{—} |
|---|---|---|---|
| Counter | Class | CYCLE_INDEX | INDEX |
| 3 bits | 1 bit | 1 bit | 3 bits |

As illustrated in Table 4, the first 3 bits define the Duration Counter, the next 1 bit defines Slotted Class, the next 1 bit defines SIGN_SLOT_CYCLE_INDEX, and the final 3 bits are used for defining SLOT_CYCLE_INDEX.

The SIGN_SLOT_CYCLE_INDEX bit is set to ‘0’ or ‘1’ as described in conjunction with Table 1. For example, if the SIGN_SLOT_CYCLE_INDEX bit is set to ‘0’, it indicates that SLOT_CYCLE_INDEX is a negative number. However, if the SIGN_SLOT_CYCLE_INDEX bit is set to ‘1’, it indicates that the SLOT_CYCLE_INDEX is a positive number. Additionally, in Table 3, the RESERVED bits are used to match octets.

An example of the Duration Counter in Table 4 in accordance with an embodiment of the present invention can be illustrated as shown in Table 5 below.

TABLE 5

| Field (3 bits) | Time |
|---|---|
| 000 | stop fast packet paging operation |
| 001 | 30 sec |
| 010 | 60 sec |
| 011 | 120 sec |
| 100 | 5 min |
| 101 | 10 min |
| 110 | 30 min |
| 111 | Infinity |

As illustrated in Table 5, 3-bit values can be matched to set desired times of the Duration Counter.

The Slotted Class bit of Table 4 indicates whether a mobile station will operate in a non-slotted mode or a slotted mode for a particular service. Additionally, a time for which the packet suspended mode available for the fast packet paging procedure is maintained, is determined by a value of the Duration Counter. After receiving the SDB message, the base station and packet control function (BS/PCF) drives a timer designated in the Duration Counter, applies the fast packet paging procedure until the timer expires, and returns to an original normal mode if the timer expires.

If the service is ended or in operation, the mobile station sets a new value to the FAST_PKT_PAGE_INFO field in an SDB before transmitting the SDB to the base station system. In this manner, the mobile station can change an SCI, extend or suspend the fast packet paging operation. That is, if the mobile station sets the Duration Counter in the FAST_PKT_PAGE_INFO field to a value other than ‘000’ while operating with a new SCI, the mobile communication system reactivates the Duration Counter thereby extending the fast packet paging operation. If the mobile station sets the Duration Counter in the FAST_PKT_PAGE_INFO field to ‘000’ before transmitting the SDB, the moble communication system suspends the fast packet paging operation and returns to the original normal mode.

When a mobile station performs an Inter-PCF Dormant Handoff, the mobile station returns to the normal mode. This results because there is new SCI information for a mobile station in a PCF located in a target area.

Returning to FIG. 3, after transmitting the Short Data Ack in step 403, the base station 320 transmits the SDB directly to the corresponding mobile station 310 using a DBM message in step 404. In step 405, the mobile station 310 generates a Layer 2 Ack signal in response to the SDB from the base station 320 and transmits the Layer 2 Ack signal to the base station 320. If the base station 320 fails to receive the Layer 2 Ack signal, the base station 320 informs the packet control function 330 of the failure to receive the Layer 2 Ack signal. The packet control function 330 then starts a reactivation procedure with the mobile station 310. The reactivation procedure is performed by setting up a traffic channel (TCH). Therefore, by rapidly performing an SDB call receiving procedure without interaction with a mobile switching center, the base station system can rapidly transmit a received PPP frame in an SDB format to the mobile station.

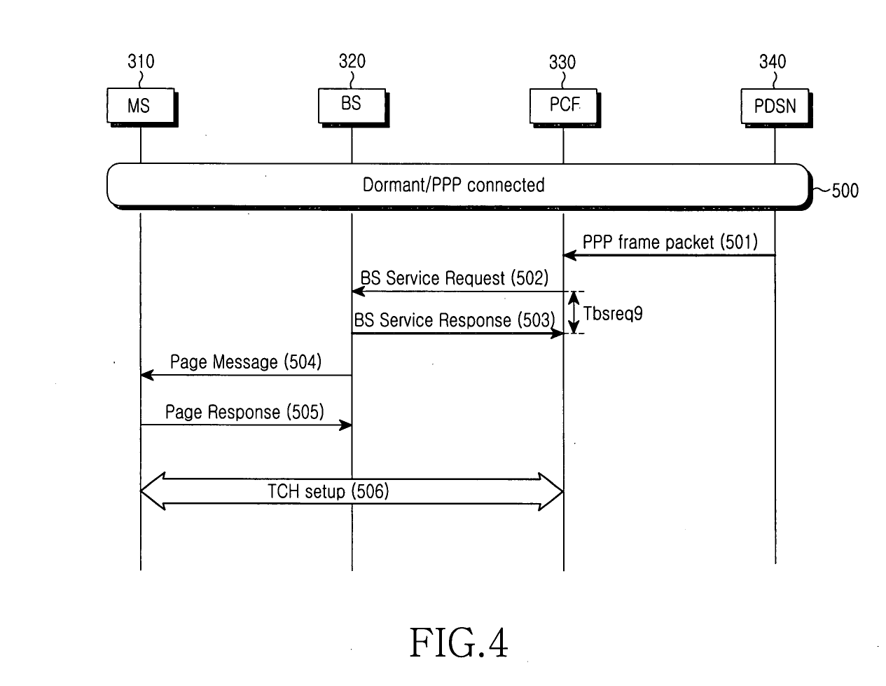

FIG. 4 is a basic signaling diagram illustrating an example procedure for receiving a data call according to an embodiment of the present invention. Referring to FIG. 4, a packet data service node (PDSN) 340 sends a PPP frame to a packet control function (PCF) 330 in step 501. The packet control function 330 then preferably determines whether it will send the PPP frame received from the packet data service node 340 with an SDB or a traffic channel. Such a determination is performed in the methods described in connection with FIG. 3.

When the determination is completed, the packet control function 330 buffers the packet and delivers a BS Service Request message to the base station 320 to open a traffic channel in step 502. The packet control function 330 delivers paging information of the mobile station 310 stored therein, such as location information, SCM and SCI, to the base station 320 together with the BS Service Request message.

Upon receiving the BS Service Request message, the base station 320 sends a BS Service Response message to the packet control function 330 in step 503. Thereafter, in step 504, the base station 330 transmits a paging message directly to the mobile station 310. In step 505, the mobile station 310 transmits a Page Response message to the base station 320 in response to the paging message received from the base station 320. The base station 320, upon receiving the Page Response message, starts a traffic channel setup procedure in step 506. In this manner, it is possible to rapidly perform a data receiving procedure without interaction with a mobile switching center. In addition, the base station system can rapidly forward a received PPP frame to the mobile station.

As illustrated in the foregoing figures and description, application of the embodiments of the present invention enable fast reception of a call, thereby improving the quality of the call. In addition, unnecessary interaction with a base station is reduced, thereby reducing a system load.

While the embodiments of the invention have been shown and described with reference to certain preferred embodiments thereof, it will be understood by those skilled in the art that various changes in form and details can be made therein without departing from the spirit and scope of the invention as defined by the appended claims.

1. A method for delivering a received frame packet, which is to be transmitted from a packet data service node to a mobile station in a dormant state by a packet control function in a mobile communication system, which is capable of providing data service or Push-To-Talk (PTT) service to the mobile station, via a base station connected to the packet control function, the method comprising the steps of:
delivering the received packet data and paging data to the base station where the mobile station in the dormant state is located using the packet control function; and
forming the received packet data into an SDB (Short Data Burst), including the SDB in a DBM (Data Burst Message) message and transmitting the DBM message to the mobile station using the base station upon a determination that an analysis result of the received paging data indicates that the mobile station in the dormant state has requested fast packet paging, and upon a determination that the base station can currently provide the fast packet paging.

2. The method of claim 1, wherein the paging data includes location information of the mobile station in the dormant state, SCI (Slot Cycle Index), and SCM (Station Class Marker).

3. The method of claim 1, wherein the fast packet paging is requested when an SCI value is set to a negative number or the base station operates in a non-slotted mode.

4. The method of claim 1, wherein the fast packet paging is requested by the mobile station during data communication and the fast packet paging is performed using location information of the mobile station, SCI, SCM, a fast packet paging enable bit and a timer value, wherein the location information of the mobile station, SCI, SCM, fast packet paging enable bit and timer value are stored in the packet control function.

5. The method of claim 4, wherein a request message for the fast packet paging includes a duration counter value indicating a time required for fast paging, and the fast packet paging is performed for the duration timer value.

6. The method of claim 5, wherein the fast packet paging operates in a normal mode when a predetermined time expires.

7. The method of claim 1, further comprising the step of:
determining whether the packet control function can transmit a frame packet without an SDB, wherein the packet is received from the packet data service node with an SDB, if there is no request for transmitting the received frame packet with the SDB.

8. The method of claim 7, wherein the packet control function determines to transmit the received packet data without an SDB, wherein the packet is received with the SDB, if a size of the received frame packet is smaller than a predetermined size.

9. The method of claim 7, wherein the packet control function determines to transmit the received packet data without an SDB, wherein the packet is received with the SDB, if a reception number of the received frame packet is smaller than or equal to the possible maximum transmission number per predetermined time.

10. The method of claim 1, wherein the base station stops performing an interaction procedure with a mobile switching center during packet paging or SDB paging to the mobile station.

11. A method for performing paging upon receiving a frame packet to be transmitted to a mobile station in a dormant state in a mobile communication system capable of providing packet data service to the mobile station via a base station, the mobile communication system including a packet data service node capable of receiving packet data, and a packet control function connected to the packet data service node, the method comprising the steps of:
determining whether fast paging is requested for the received packet data using the packet control function; and
if fast paging is requested, delivering the received packet data via a base station where the mobile station is located through an SDB (Short Data Burst) message.

12. The method of claim 11, wherein the determination step comprises the step of determining whether fast paging is requested by the packet data service node.

13. The method of claim 11, wherein the determination step comprises the step of determining whether the received packet data is smaller than a predetermined size, and determining that fast paging is requested if the received packet data is smaller than the predetermined size.

14. The method of claim 11, wherein the determination step comprises the step of determining whether a reception number of packet data is smaller than a threshold within a predetermined time, and determining that fast paging is requested if the reception number of the packet data is smaller than the threshold within the predetermined time.
